(19) United States
(12) Patent Application Publication
(10) Pub. No.: US 2012/0079067 A1
(43) Pub. Date: Mar. 29, 2012

(54) System and Method for Enhanced Social-Network-Enabled Interaction

(75) Inventors: Trevor Stout, Los Altos, CA (US); Marius Seritan, Davis, CA (US); Shawn Cunningham, Emerald Hills, CA (US)

(73) Assignee: YAP.TV, INC., Los Altos, CA (US)

(21) Appl. No.: 13/246,793

(22) Filed: Sep. 27, 2011

Related U.S. Application Data
(60) Provisional application No. 61/386,926, filed on Sep. 27, 2010.

(51) Int. Cl. G06F 15/16

(52) U.S. Cl. 709/217

(57) ABSTRACT

Systems and methods are provided to provide enhanced social networking to users of remote computing devices. Users of the disclosed system are able to interact with other participants in real-time and in relation to experiencing live or recorded media content. The system receives audio data that is captured by the user's device, wherein the audio data includes a processed or unprocessed audio sample of the media content being viewed by the user. The audio sample is compared to a database containing audio samples from a number of media programs to determine whether a match exists. If a match is found, the system determines other participants who are, at the same time, viewing the matched media program and establishes a connection between each of them. The connection enables participants to exchange real-time messages, participate in polls, and receive offers.

### RELATED APPLICATIONS

The present application claims priority to U.S. Pat. App. Ser. No. 61/386,926, filed Sep. 27, 2010 and entitled “System and Method for Enhanced Social-Network-Enabled Interaction,” the disclosure of which is hereby incorporated by reference in its entirety herein.

### FIELD OF THE TECHNOLOGY

At least some embodiments of the present disclosure relate to providing real-time interaction between participants over a network and relative to scheduled and/or unscheduled media events.

### BACKGROUND

Social networks in the context of human society is a natural phenomena that has been studied and manipulated over several centuries. More relevant to the present time, social networking services have for many become as much a part of daily living as using a telephone, for example. A social networking service is usually an Internet based service, platform, or site, that has been implemented to build on and reflect what we already know about the nature of social networks. Social networking services visually reflect and help build social relations among people having shared interests, values, and/or activities. A social network service essentially consists of a representation of each user (i.e., a profile), his/her social links, and a variety of additional services.

It is widely believed that social networking services have made it possible for people to become more active in socializing with and relating to “like-minded” people. However, some would argue that such relationships built on, or maintained, within the sterile environment of the Internet are shallow and lack the physical interaction that is intrinsic to the nature of human beings. In an effort to compensate for the lack of a more personal interaction within social networking services, scientists and engineers have conjured various means for closing the geographic divide that is inherent to online social networking. Such efforts include, for example, providing real-time audio and video exchange between members of a social network. Employing additional human senses to the online social networking experience have improved the overall experience. However, any such exchange continues to occur in a somewhat artificial, or studio-like, environment. In other words, the ability to interact with other people while simultaneously engaging in real-life activities is lacking. For example, the level of interaction between a mother and daughter working together in a kitchen to prepare a meal simply cannot be replicated when the mother and daughter are physically separated with each residing in their own unique environment. Other than verbal communication, there is minimal real-time sharing of real-life experience within a social network service.

### SUMMARY OF THE DESCRIPTION

Systems and methods are provided for real-time interaction between users over a network in relation to live and/or pre-recorded media content. Some embodiments are summarized in this section.

In one embodiment, a system links users who are simultaneously viewing a broadcast and provides the users with the ability to communicate among themselves. This is facilitated by a system configured to receive a first audio stream from a first device of a first user. The system compares the first audio stream to stored audio streams in order to identify a second audio stream corresponding to the first audio stream. Based on locating a match to the first audio stream, the system retrieves a content identity corresponding to the second audio sample. The content identity may include, for example, the name and episode of a television sitcom broadcast. The system compiles information based on the content identity and transmits the information to the first device.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 is a block diagram showing a functional overview of an exemplary system for social-networked interaction in accordance with one embodiment;

FIG. 2a is a diagram showing a simplified overview of an exemplary system for social-networked interaction in accordance with one embodiment;

FIG. 2b is a diagram showing a simplified overview from the perspective of a local head end of an exemplary system for social-networked interaction in accordance with one embodiment;

FIG. 2c is a diagram showing a simplified overview from the perspective of a user device of an exemplary system for social-networked interaction in accordance with one embodiment;

FIG. 3 is a block diagram showing an overview of an XMPP architecture of an exemplary system for social-networked interaction in accordance with one embodiment

FIG. 4 is a block diagram showing a spoiler blocking configuration of an exemplary system for social-networked interaction in accordance with one embodiment; and

FIG. 5 is a block diagram showing various computing and networking hardware used in the implementation of an exemplary system for social-networked interaction in accordance with one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In one embodiment, the system and method described herein comprise social networking related services that allow participants to interact in real-time in direct relation to shared events. The system allows participants to share thoughts and ideas that are based on, or stem from, the simultaneous viewing of content. The system further facilitates social-network-enabled interaction through real-time control, participation, and communication relative to entertainment and/or educational content.

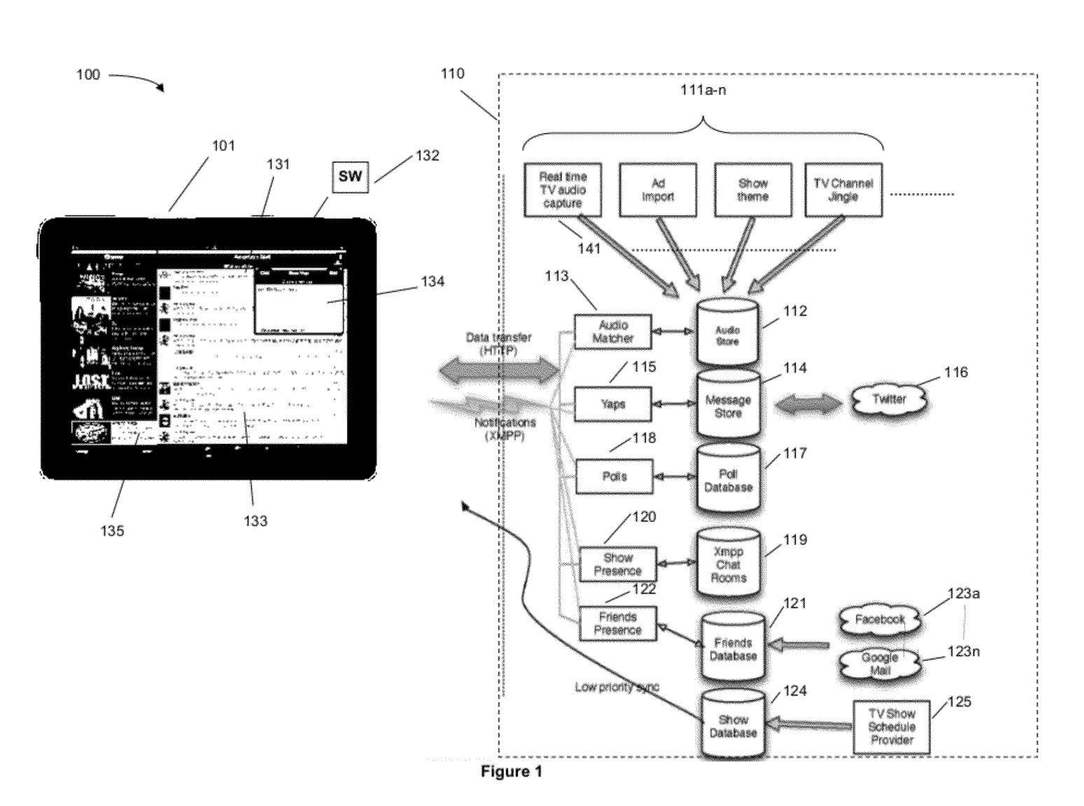

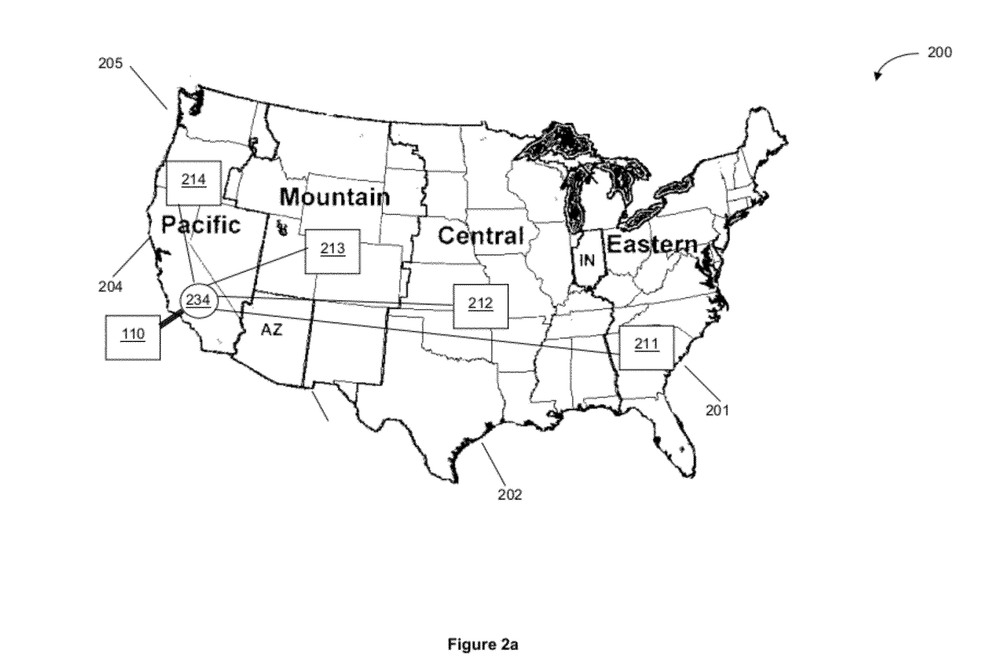

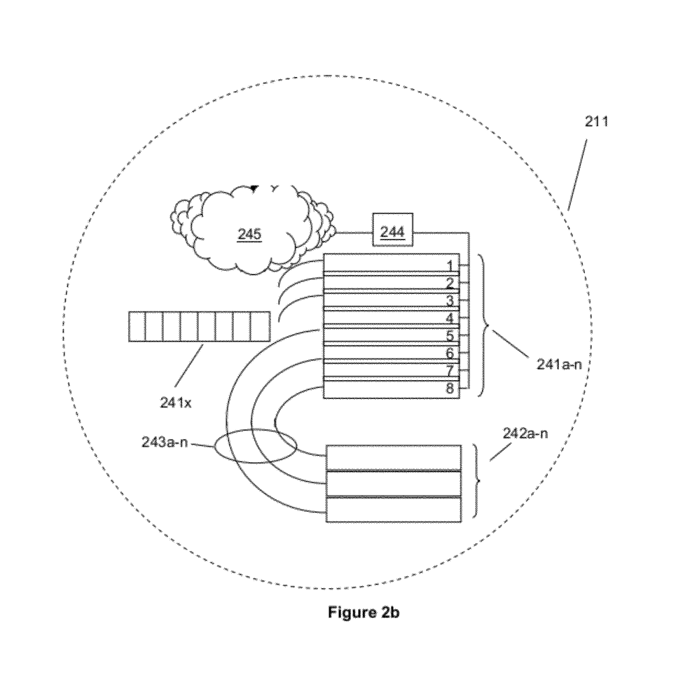

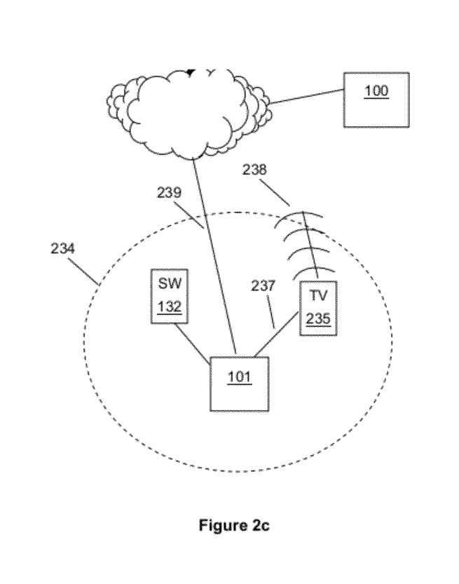

FIG. 1 shows a functional overview of system 100 with an exemplary operating center (system) 110 and an exemplary client device 101, according to one embodiment of the system and method disclosed herein, with an exemplary list of services. Shown at the top right of FIG. 1 is an exemplary list of external services 111a-n, such as real-time TV audio capture, further discussed in the subsequent description of FIG. 2. The exemplary services 111a-n are used to import external data, such as TV guide line-ups and real-time audio collected in a proprietary system in a head-end 141 (also further discussed in the description of FIG. 2). External data for import may further include advertising imports from advertising partners, both from proprietary advertising partners of the services offered by the system in conjunction with network, cable and satellite, as well as from other advertising partners. Additional imports may be made in some cases of show themes of partnering shows and television channel jingles to overlay the recognized features, and also future additional enhancements and expansion.

As the user connects using device 101, which has application 132 running in the background, the system presents a screen 131 to the user. Screen 131 displays the current line-up of channels 135. In one embodiment, application 132 runs as an application (e.g., browser plug-in) on a browser and/or an operating system, as provided by the device maker and/or operator. The channel currently playing may be highlighted for emphasis. Window 133 displays the current discussions (e.g., “yaps”) relating to the programming.

As described herein, the system utilizes both the transfer of the data in the visual field, as well as notifications and the transfer of a sound stream to identify the programming (i.e., channel) that the user is currently viewing. As used herein, the terms “view”, “viewing”, “watch” and “watching” may be used interchangeably and convey the act of hearing and/or seeing a media based event (e.g., television, program, movie feature, music, etc.).

The audio matcher module 113 is configured to match the audio of the user's channel to all channels available in the audio capture head end 141, which is part of system 200. The audio capture head 141 is discussed in greater detail in the discussion below for FIG. 2.

Module 113 is in communication with an audio store 112, which maintains audio data for an arbitrary length of time such as, for example, two weeks (although this length of time could just as well be two months or two years, for example), thus enabling the system to match the audio of programs previously recorded by, for example, a digital video recorder (DVR). Moreover, the discussions are stored in data store 115, which is connected to message store 114, further described below. In one embodiment, either the content or the users may launch certain polls from poll module 118. For example, various polls may be displayed as an overlay 134 on screen 131. As used herein, a poll may comprise any one or more inquiries that are defined by users, administrators, or any designated third party for the purposes of obtaining information from one or more users of the disclosed system.

In one embodiment, module 113 may be implemented at the client device 101 (i.e., as a component of SW 132) rather than at the operating center 110, for example, in order to reduce the quantity of data that may be transmitted between the client 101 and operating center 110. Further, practitioners will appreciate that the features of the variously disclosed software and/or hardware modules may be implemented in a combination of operating-center-based and device-based software. Moreover, and as explained herein, the system illustrated in FIG. 1 is presented for explanation and may not include every element and component for which explanation is not necessary to those of ordinary skill in the art. For example, it should be appreciated that while not illustrated in FIG. 1, the client device 101 may similarly include many of the hardware components described relative to those of the operating center 110. Such components may include, for example, microprocessors and various memory structures used to carry out instructions for receiving and processing information, and transmitting and storing information.

Display of polling data may be configured, such that polls by networks, partner shows, advertisers, and/or users may be added. The poll results may then be collected from participating users and combined by any and all parties involved. Poll results may be stored in poll database 117, which is in communication with the polls module 118.

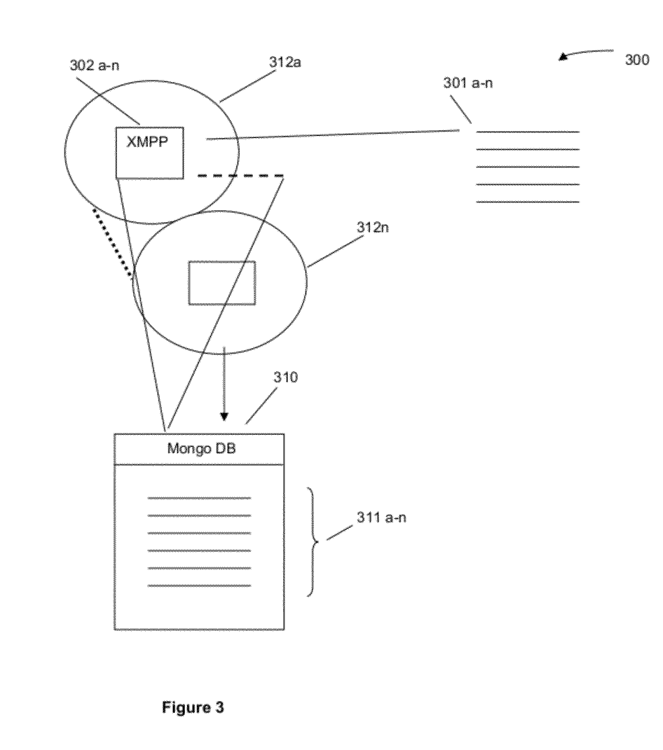

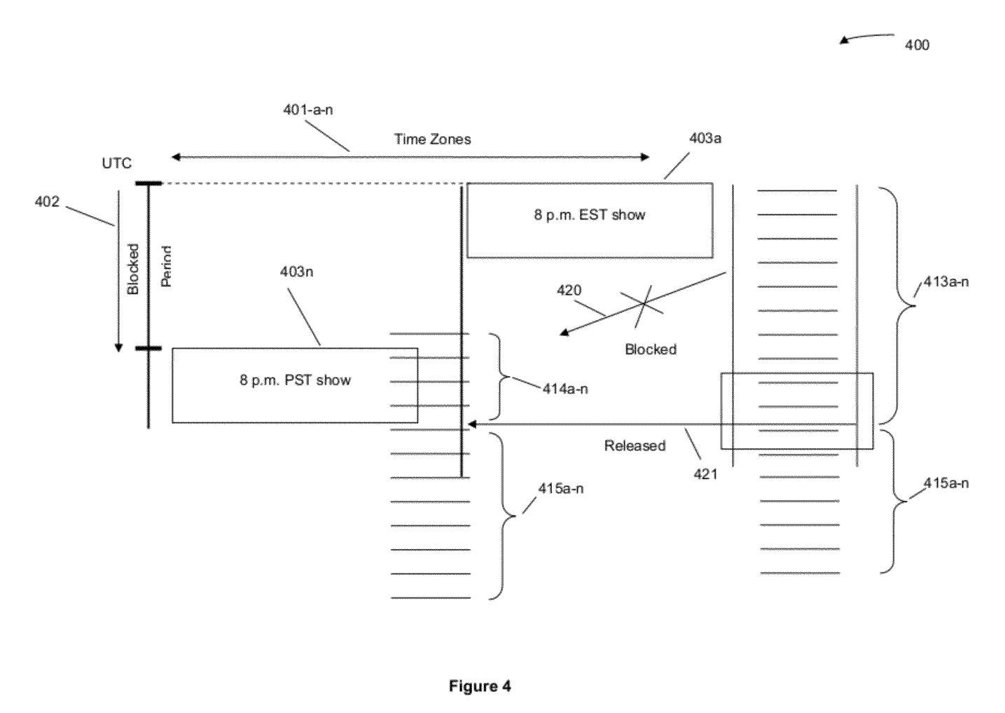

In one embodiment, chat rooms operate using an extensible messaging and presence protocol (XMPP) chat system, using in part, presence module 120, which communicates also with device 101, and XMPP chat room(s) 119 (as well as additional features further described below). Further, the friends presence module 122 may communicate with user device 101, enabling friends, for example, to “see” each other, as well as in some cases enabling direct offers, etc., by partners. In one embodiment, an enhanced architecture enables chat rooms to maintain, for example, millions of simultaneous participants, as further described in the discussions of FIG. 3 and FIG. 4 below.

Additional information in operating center 110 may include a friends presence module 122 and friends database 121. These modules may interface with existing or new services 123a through 123n, such as, for example, Facebook, MySpace, Ping, Google, chat, and the like. Show database 124 contains lists of current and previous content (e.g., programs, media events, etc.) in the electronic program guide (EPG). In one embodiment, EPG data is imported from external sources 125, including but not limited to such sources as Tribune, Gemstar/Newscorp, Microsoft, and the like.

In one embodiment, sound profile analysis is performed on a server in center 110 and is facilitated through execution of a sound matcher module 113, which digitally compares a sound stream with stored sound stream samples. The sound matcher 113 enables detection within in a few seconds, for example, of the channel or program that the user is viewing, and whether it is live or recorded, on a DVR for example, by comparing a sound stream from the current viewing with sound signatures from a plurality of live captured and/or previously captured sounds that are maintained within audio store database 112.

FIG. 2a illustrates a simplified exemplary overview of a system 200, according to one embodiment of the system and method disclosed herein. As illustrated by the simplified map 205 of the United States, content (i.e., broadcast media) is distributed across the country. A local head end 211, 212, 213, and 214, is respectively located in each time zone 201, 202, 203, and 204. In accordance with this embodiment, a user at location 234 in Los Angeles, is connected to operating center 110. This provides data collection within localized geographic regions, typically by time zone, such collection including the capture of sound data of some or many broadcasts across various time zones. In one embodiment, the objective may not necessarily be to capture all channels, but rather the top 20 to 100 channels nationwide, for example, while capturing as many of these channels as possible in each time zone.

Each head end, as illustrated in FIG. 2b in a detailed example of local head end 211, contains a set of receiver boxes 242a-n for receiving locally available cable and or satellite signals (not shown) and connected to a set of digital signal processor (DSP) units 241a-n. With occasional reference to FIG. 1, each of the DSP units, as shown in unit 241x, contains an eight-channel DSP, which DSP creates digital signatures of the sounds of the channels viewed and transmits those signatures via server 244 and Internet connection 245 to head end 141 located at center 110. In one embodiment, head end 141 collects this data nationwide from all time zones, or potentially even worldwide, and stores the data in the audio store database 112. In some scenarios, local head ends may be available in different geographic regions, such as, for example, Asia, Asia-Pacific, Europe, etc., or in different countries. This data may be used to match stored sound data with sound data from a user's device 101 in a location such as, for example, Los Angeles 234.

In the detailed example shown in FIG. 2c, the user interacts with a device 101, which may comprise any suitable hand-held computing device. The device uses a microphone (not shown) to collect sound information 237 emanating from television (TV) 235. Device 101 may comprise any suitable electronic device, including but not limited to, an iPhone, iPad, Blackberry, Android phone, or any other type of smart phone, tablet PC, or dedicated device having sufficient resources and capabilities to perform the functions disclosed herein.

The collected sound information 237 is processed by software 132 and transmitted via Internet connection 239, which connection could be, for example, a wireless connection, or any other suitable connection of various known wireless connections, to an operating center 110, as previously described in reference to FIG. 1.

In one embodiment, sound profile analysis is performed on a server in center 110 (shown in FIG. 1). This analysis is performed in sound matcher 113 (see FIG. 1) and enables detection, typically within a few seconds, of the channel and/or program that the user is currently viewing, and whether it is live or recorded, on a DVR for example, by comparing it with sound signatures from many live captured and previously captured sounds in audio store database 112 (see FIG. 1). In one embodiment, networking may be facilitated by way of 3G, 4G, or any other suitable wireless protocol, or any suitable local wireless connection, such as Wi-Fi, Bluetooth, etc., which is then connected via DSL or any other suitable networking means back into the Internet backbone.

FIG. 3 provides an overview of the XMPP architecture 300 in accordance with one embodiment. Because most XMPP servers have a limit of only a few thousand participants, in most situations such servers are clustered together, as shown in FIG. 3. Each server 312a-n has its own local roster of participants 301a-n, which could be a few hundred or a few thousand. A few hundred to a few thousand of these local XMPP clusters may be operated, for example, grouped into regions (with possibly additional servers in regional head ends 211-214, not shown), which arrangement has advantages described below. Those local and regional groups may then connect to database 310, which includes a global roster of participants 311a-n. In one embodiment, when a user signs in, the system locates the user in the global database and assigns a suitable local chat group from servers 312a-n, according to the user's current geographical location.

In one embodiment, the location of the user may be determined based on a global positioning system (GPS) device attached to the user's device 101. In various other embodiments, the geographic location of the device 101 (and user) may be determined and/or provided by way of a location defined in a user profile, a user profile captured from other social networks (e.g., Twitter, Facebook, MySpace, etc.), an IP address, cellular location, and the like.

By limiting the localization to a specific area, the system may provide local services such as spoiler alert or spoiler blocking, in accordance with one embodiment. Spoiler blocking prevents the chat or twitter posts of people in, for example, time zone 201 (the U.S. east coast) from reaching people in time zone 204 (the U.S. west coast) until the event under discussion has finished on the west coast, thus avoiding spoiling the show.

FIG. 4 provides an overview of an exemplary spoiler blocking system 400, according to one embodiment of the system and method disclosed herein. The arrow across the top of FIG. 4 illustrates the span of time zones 401a-n. In accordance with this example, the subject event occurs during time block 403a on the east coast, beginning at 8:00 p.m. EST, while the same show (i.e., event) occurs during time block 403n, beginning at 8:00 p.m. PST, on the west coast. “Tweets” 413a-n, sent from the start of time block 403a to the end of time block 403n, are blocked, as indicated by crossed out arrow 420. The system releases these tweets when the event finishes on the west coast (at the end of time block 403n), as indicated by arrow 421. Thus, users may enjoy even the last few seconds of the event without any spoilers. Prior to the end of the event, chat rooms on the west coast are kept separate from those on the east coast, and users in the west coast geographical region see only messages 414a-n. When the event has ended on the west coast, all messages 413a-n are released and synchronized with chat rooms on the west coast. Then, all messages 415a-n are the same in all chat rooms in all geographical areas.

The above description is presented for explanation only, and practitioners will appreciate that the disclosed system and method is applicable to multiple geographical chat regions and multiple airings of the same event. For example, an event appearing in a yet further western time zone, for example, Hawaii, could have its own chat room specific to it's geographical region, to which the spoiler blocking system could be similarly applied. A globally broadcast event might have time-delayed localized chat rooms worldwide, according to the time of showing in each region. In the case of an event shown simultaneously (e.g., live) worldwide, chat rooms worldwide may be synchronized, using database 310. In an alternative embodiment, the chat rooms are grouped into localized geographical regions so that users see physically local chat messages first and have improved interactivity with these local messages.

A feature of one embodiment disclosed herein, for example, is that if a user is viewing an event in a public venue such as a sports bar, the user is still able to participate in chat, because the device 101 would continue to recognize the specific event and connect the user accordingly to the appropriate chat room.

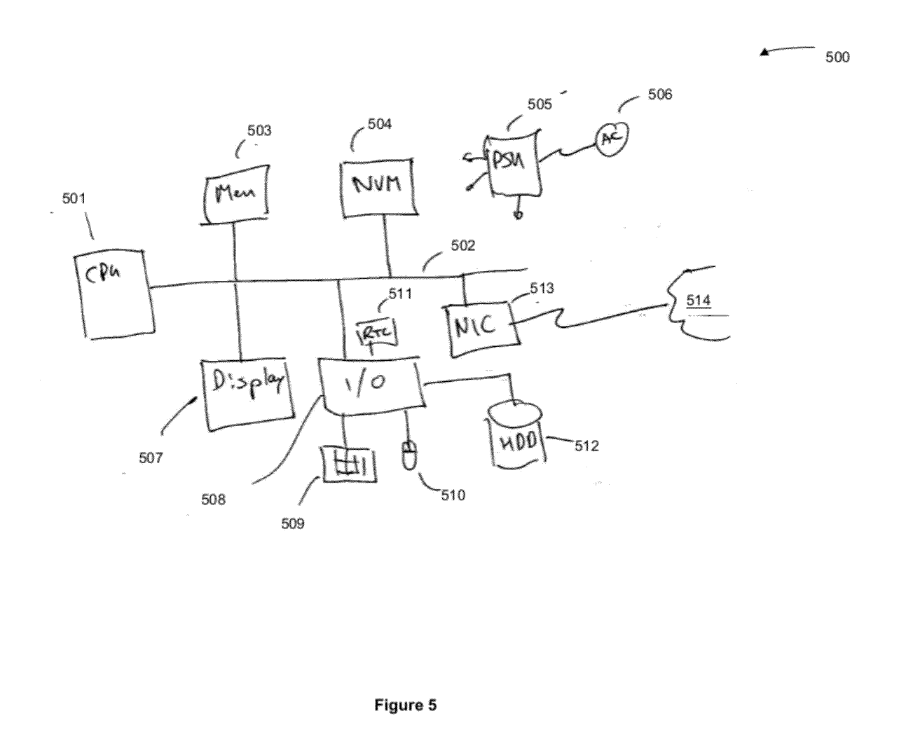

FIG. 5 provides an overview of a computer system 500 that may be implemented in any of the various locations throughout system 100. As used herein, computer system 500 may comprise any computer apparatus that provides (i.e., stores and/or transmits) information in a form accessible by a machine (e.g., a computer, network device, personal digital assistant, manufacturing tool, any device with a set of one or more processors, etc.). Practitioners will appreciate that various modifications and changes may be made to computer system 500 without departing from the scope of the disclosed systems and methods.

CPU 501 is connected to bus 502, to which bus is also connected memory 503, nonvolatile memory 504, display 507, I/O unit 508, and network interface card (NIC) 513. I/O unit 508 may be connected to keyboard 509, pointing device 510, hard disk 512, and real-time clock 511. NIC 513 connects to network 514, which may be the Internet or a local network, which local network may or may not have connections to the Internet.

Practitioners will appreciate that modifications and variations of the system and method disclosed herein may be made by one skilled in the art without departing from the spirit of the novel art of this disclosure. The following paragraphs present various additional embodiments.

In one embodiment, viewers of broadcast content may be connected by a method that includes a system for capturing sounds emanating from a broadcast viewing device, sending the captured data, processed or unprocessed, to a server, and comparing it with a library of available audio. The system is configured to identify the broadcast content by matching the sound characteristics of the emanated sounds with data in the library of available sounds. Other data, such as, for example, content recorded earlier on a recording device may also be identified. Moreover, a handheld device such as, for example, a smart phone, may capture the emanated sounds.

A viewer, or participant, of the system may be connected to a group of people watching the same content, for example, through a social networking type of chat room. In one scenario, the chat room may include both friends and other viewers, while in another, the chat room may contain only friends.

The system may include an indicator to denote friends that have watched particular content previously or are watching it as a recorded event. In some cases, friends from other social networking sites may be invited to join the service to better participate. For example, GPS data may be used to indicate that friends or other people nearby are watching the same content.

In one embodiment, content available to users in another geography and/or time zone may be blocked from the view of a specific user. In some cases, a viewer is provided a display showing friends that are viewing the same content as the user. In other cases, the viewer may be introduced to other viewers having, for example, shared interests, values, experiences, and the like.

In one embodiment, a viewer may enter the broadcast channel that is being currently watched into an interface of device 101, rather than relying on the disclosed sound detection. In another embodiment, the device 101 may inquire of the entertainment system to determine what content or broadcast channel the viewer is watching, for example, through infrared (IR) exchanges or wireless or internet queries, as some set top boxes, for example, allow console queries to be sent via Internet or wireless interfaces.

In one embodiment, a viewer can see what programs friends are watching and switch programs accordingly. Further, the system may occasionally ask the viewer for information such as channel, provider, etc. to expand its knowledge about channel availability. For example, during ad breaks, or at a certain time of the program, ads and or special offers may be displayed with which the user may interact. In some cases, the broadcaster and or broadcast provider may initiate the interactive content. Such interactions may, for example, lead to follow-up activities, including but not limited to, participation in polls, joining of groups, commercial transactions, and the like. In one embodiment, the user may create his own polls. Such polls may be used, for example, to poll only friends or, in other cases, all participants viewing the same broadcast event.

In one embodiment, viewers of broadcast content may be connected by a system for capturing sounds emanating from a broadcast viewing device and the sounds are transmitted, in either a processed or unprocessed state to a server. The captured sound is compared with a library of available sounds, such that the system may identify the broadcast being watched by matching the sound characteristics of the emanated sounds with data in the library of available sounds. In one embodiment, a content broadcaster and/or broadcast provider may access all, or a subset of, demographic data relating to participants of the disclosed system. The system may allow participants to opt-in or opt-out of such release of demographic information.

In one embodiment, the system includes a Push To Talk chat feature, that when enabled, allows a group of users to chat verbally when not in the same location. This dynamically creates the group based on existing friend relationships and broadcasts viewed.

In one embodiment, the system provides offers to all or a subset of participants. Offer creation and distribution may be based on, for example, a participant's profile, past and current usage, the viewer's network of related viewers, and the like. Offers may include, for example, invitations to exclusive content or usage of certain system features.

In one embodiment, an Application Programming Interface may be made available, allowing third parties to create specific enhancements, leveraging the knowledge available to enhance the viewer's experience. These modifications and variations do not depart from its broader spirit and scope, and the examples cited here are to be regarded in an illustrative rather than a restrictive sense.

Various computing hardware, software, and networking components for facilitating the disclosed features of system 100 have been described herein. The various hardware components include, for example, computing devices comprising one or more microprocessors and memory structures (e.g., RAM and ROM). In addition to the specifically disclosed application programming logic residing at the client device 101 and operating center 110, the system 100 may incorporate various database management systems, security modules, user management modules, firewalls, and the like. The subsequent paragraphs describe such hardware and software features in greater detail; however, practitioners will appreciate that the following is neither entirely inclusive or exclusive of the components that may be utilized in the execution of the disclosed features.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### OTHER ASPECTS

The description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
receiving a first audio stream from a first device of a first user;
comparing, at a computing apparatus, the first audio stream to stored audio streams to identify a second audio stream corresponding to the first audio stream;
retrieving, by the computing apparatus, a content identity corresponding to the second audio stream;
compiling, by the computing apparatus, information based on the content identity; and
transmitting, by the computing apparatus, the information to the first device.

2. The method of claim 1, further comprising:
establishing, by the computing apparatus, a connection between the first device and a second device of a second user;
receiving, at the computing apparatus, a communication from the first device; and
transmitting, by the computing apparatus, the communication to the second device.

3. The method of claim 2, wherein the communication is to be viewed from a chat interface of at least one of: the first device and the second device.

4. The method of claim 2, wherein the first device is at least one of: a smartphone, a personal computer, a tablet computer, a gaming console, and a television.

5. The method of claim 1, further comprising receiving first audio data, wherein the first audio data includes at least one of: a first user identity and a GPS coordinate.

6. The method of claim 2, wherein the information includes at least one of an offer and an invitation that can be selected, at a predetermined time, by at least one of the first user and the second user.

7. The method of claim 1, further comprising making a determination that the first device and the second device are in differing time zones, and in response to the determination not establishing the communication.

8. The method of claim 1, further comprising storing the information in a database that maintains demographic information.

9. The method of claim 8, further comprising granting access to the database, wherein said access facilitates analysis of the information in relation to at least one of: offers, invitations, and inquiry responses.

10. The method of claim 1, further comprising:
transmitting, by the computing apparatus, an inquiry to the first device;
receiving, from the first device, a reply to the inquiry; and
performing, by the computing apparatus, an action based on the reply.

11. The method of claim 2, wherein the communication comprises profile information associated with at least one of: the first user and the second user.

12. A computer-storage device storing instructions which, when executed by a computing apparatus, cause the computing apparatus to perform a method comprising:
receiving a first audio stream from a first device of a first user;
comparing the first audio stream to stored audio streams to identify a second audio stream corresponding to the first audio stream;
retrieving a content identity corresponding to the second audio stream;
compiling information based on the content identity; and
transmitting the information to the first device.

13. The computer-storage device of claim 12, further comprising:
establishing, by the computing apparatus, a connection between the first device and a second device of a second user;
receiving, at the computing apparatus, a communication from the first device; and
transmitting, by the computing apparatus, the communication to the second device.

14. The computer-storage device of claim 12, wherein the first audio stream corresponds to at least one of: a live media broadcast and a pre-recorded broadcast.

15. The computer-storage device of claim 12, wherein the second audio stream corresponds to at least one of: a live media broadcast and a pre-recorded broadcast.

16. A system, comprising:
at least one processor; and
memory storing instructions configured to instruct the at least one processor to:
receive a first audio stream from a first device of a first user;
compare the first audio stream to stored audio streams to identify a second audio stream corresponding to the first audio stream;
retrieve content identity corresponding to the second audio stream;
compile information based on the content identity; and
transmit the information to the first device.

17. The system of claim 16, wherein the memory storing instructions are further configured to instruct the at least one processor to:
establish a connection between the first device and a second device of a second user;
receive a communication from the first device; and
transmit the communication to the second device.

18. The system of claim 16, wherein the first audio stream is configured for compilation or to be compiled at the first device based on sound received by a microphone connected to the first device.

19. The system of claim 16, wherein the information includes at least one of: a second user identity, second user information, polling data, an offer, and an invitation.

20. The system of claim 16, wherein the memory storing instructions are further configured to instruct the at least one processor to:
transmit an inquiry to the first device;
receive a reply to the inquiry; and
perform an action based on the reply.

21. A computer-implemented method, comprising:
receiving a program identity from a first device of a first user;
retrieving, by a computing apparatus, a content identity corresponding to the program identity;
determining eligibility of the first user to communicate with a second user based on the program identity and the content identity;
compiling, by the computing apparatus, information based on the eligibility; and
transmitting, by the computing apparatus, the information to the first device.

22. The method of claim 21, further comprising comparing a first audio stream, received from the first device, to stored audio streams to identify a second audio stream corresponding to the first audio stream.
